(19) United States
(12) Patent Application Publication
(10) Pub. No.: US 2011/0086123 A1
(43) Pub. Date: Apr. 14, 2011

(54) METHOD AND DEVICE FOR MOUNTING FORMS

(75) Inventor: Stefan Bahlke, Schnakenburg (DE)

(73) Assignee: HARBURG-FREUDENBERGER MASCHINENBAU GMBH, Hamburg (DE)

(21) Appl. No.: 12/920,902

(22) PCT Filed: Mar. 4, 2009
(86) PCT No.: PCT/DE09/00320

§ 371 Date: Dec. 13, 2010

(30) Foreign Application Priority Data
Mar. 4, 2008 (DE) 10 2008 012 850.3

(51) Int. Cl. B29D 30/06; B29C 33/30; B23Q 7/00

(52) U.S. Cl. 425/195; 29/559

(57) ABSTRACT

The method and the device are used for mounting forms of a heating process of tires that are produced from an elastomeric material. Form segments of the form are held detachably by a support device. Mounting pins of a guiding element supporting the form segments, said pins being provided with a mounting profile, are guided through an insertion recess of a fixation element disposed in the region of the support device. Thereafter, a locking element of the fixation element is positioned transversely to the longitudinal direction of the mounting pin and thereby locked by the mounting profile with respect to the fixation element. Before carrying out the transversal positioning of the locking element, a tensioning element, which adjusts the fixation element in a longitudinal direction of the mounting pin, is displaced against a spring force. Thereafter, the tensioning element is reset by the spring force in order to hold the mounting profile of the mounting pin in the region of the fixation element by positive fit.

The invention relates to a method for holding a mold of a heating press for tires of an elastomer material, wherein mold segments are releasably held by a support device.

The invention additionally relates to a device for holding a mold of a heating press for tires of an elastomer material, wherein mold segments are releasably held by a support device.

Finally, the invention relates to a heating press which is equipped with the above-mentioned device.

A heating press for tires typically has a stationary base part and a head part which is positionable relative to the base part. Mold halves are held at the head part. The mold halves are positionable transversely of the lifting direction of the press head for receiving the tire blank and to once again release the finished vulcanized tire. After the mold has been completely opened, the mold is lifted in the vertical direction in order to support the lateral removal of the finished tire.

The mold segments which are used are releasably arranged at the head part of the press. This typically takes place with the use of a guide element in which the mold segments are arranged so as to be positionable relative to each other. The guide element may be constructed, for example, as a so-called container or as a C-like section that is constructed for absorbing the closing forces. When the vulcanization procedure is carried out, the guide element is typically pulled against a heating plate in order to reinforce an appropriate temperature adjustment. The guide element is fixed, as a rule, by using screws at the head part of the press. When the mold segments are being exchanged, the screws, which are hot as a rule must be loosened and the new mold segments screwed down again. The corresponding time delay of the mold exchange leads to a corresponding interruption of the production. Moreover, access to the screws is frequently difficult.

It is the object of the present invention to improve a method of the above-mentioned type in such a way that a quick mold exchange is reinforced while simultaneously achieving a high operational safety.

In accordance with the invention, this object is met by inserting holding bolts of a guide element supporting the mold segments and provided with a support profile through an insertion recess of a fixing element arranged in the area of the support device and that subsequently a locking element of the fixing element is positioned transversely of a longitudinal direction of the holding bolt, and that the holding profile is locked as a result relative to the fixing element and that, prior to carrying out the transverse positioning of the locking element, a clamping element for adjusting the fixing element in the longitudinal direction of the holding bolt is displaced by an adjusting device against a spring force, and subsequently is returned by the spring force for holding the holding section of the holding bolt in the area of the fixing element by positive engagement.

A further object of the present invention is to construct a device of the above-mentioned type in such a way that a quick mold exchange is made possible while the operational safety is high.

In accordance with the invention this object is met by a holding bolt provided with a holding profile of a guide element supporting the mold segments, which bolt is insertable through an insertion recess of a fixing element arranged in the area of the support device, and that a locking element of the fixing element is positionable transversely of a longitudinal direction of the holding bolt, and that the holding profile is lockable relative to the fixing element by the positioning of the locking element relative to the fixing element, and that the fixing element of the holding bolt is adjustable in the longitudinal direction of the holding bolt by a clamping element, and that the clamping element is displaceable by an adjusting device against a spring force of at least one spring, and is returnable by the spring force of the spring, and that in the return position, the holding profile of the holding bolt is supported in the area of the fixing element by positive engagement.

As a result of the engagement of the holding bolt in the fixing element, it is possible in a simple manner to carry out locking as well as unlocking. After the clamping element has been untensioned, it is merely necessary to displace the locking element of the fixing element in order to once again either fix or release the holding bolt.

In particular, the present invention makes it possible to carry out the lifting movement for lifting the opened mold, to clamp the molds between the heating plate and the press base and to carry out an untensioning in the area of the fixing elements prior to loosening the holding bolt through a common adjusting element, typically a hydraulic cylinder. As a result, a simple and operationally safe basic construction is made available.

By realizing the present invention, the additional mold adapter plate or additional pneumatic cylinder or additional hydraulic cylinder necessary for the releasable holding of the mold segments in accordance with the prior art are avoided. Moreover, the appearance of a gap between the heating plate used and the mold is avoided and, if the fixing element is suitably configured, fastening with different holding elements of the upwardly adjusted molds is possible. Accordingly, there is no limitation to a single fixedly predetermined circle of holes for fastening the mold.

A use of the principal cylinder of the heating press and, thus, the avoidance of an additional adjusting element is made possible by hydraulically driving the adjusting device for the clamping elements.

Two different work positions for the hydraulic cylinder can be predetermined by turning the clamping element about its longitudinal axis prior to clamping the clamping element.

A simple positioning is reinforced by predetermining the rotary movement by a pneumatic cylinder.

A simple carrying out of the locking procedure as well as an unlocking procedure is made possible by adjusting the locking element of the fixing element by a pneumatic cylinder.

A reliable holding of the mold segments as well as an effective clamping relative to a heating plate are reinforced by aligning a plurality of fixing elements relative to each other and with their respective longitudinal axes in a radial direction toward a longitudinal axis of the adjusting device.

A uniform introduction of a force is facilitated by arranging the fixing elements in relation to the longitudinal axis in a circumferential direction essentially equidistant relative to each other.

A compact construction of the locking elements is reinforced by positioning the locking element by a pneumatic drive.

A robust and mechanically stable construction is achieved in that the holding bolts, when positioning the locking element, are positioned with a shaft within a slot of the locking element.

A transmission of high clamping forces with little wear is facilitated by positioning along the slot at least one holding recess adapted to the bolt head.

A reliable locking can be ensured by monitoring a locking position of at least one safety switch.

For making available different mold fastening hole circles, it is proposed that by a positioning of the locking element at least two different locking positions are predetermined.

In the drawing, embodiments of the invention are schematically illustrated. In the drawing:

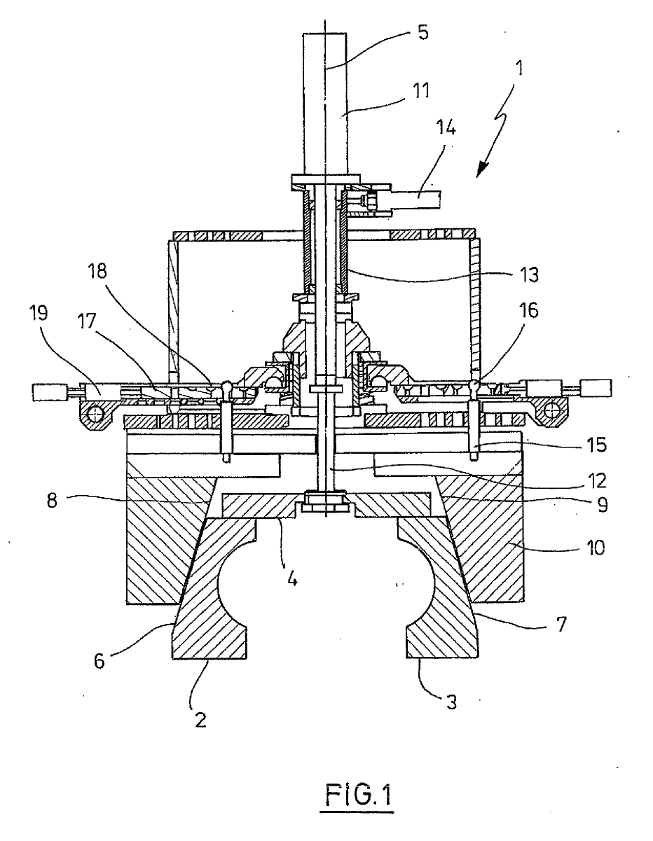

FIG. 1 is a vertical sectional view through a partially illustrated tire heating press,

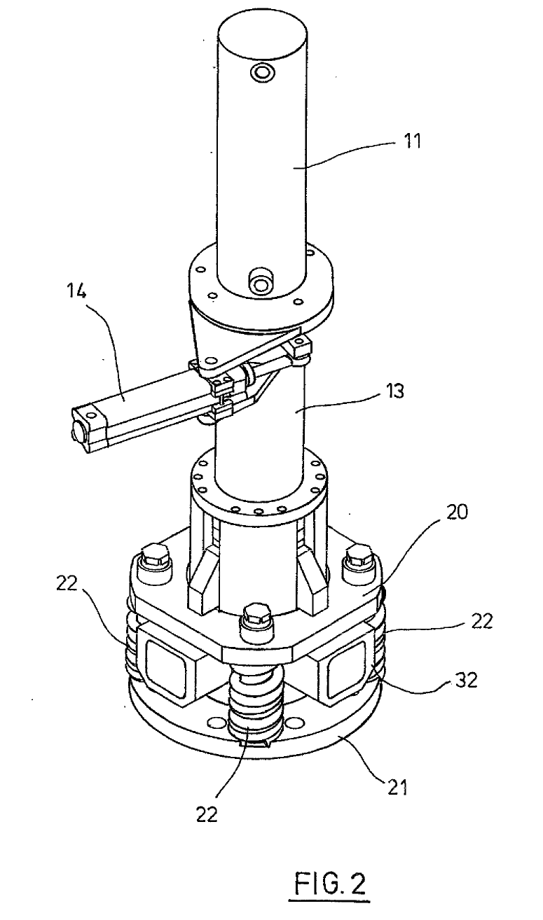

FIG. 2 is a side view of the upper press part of FIG. 1,

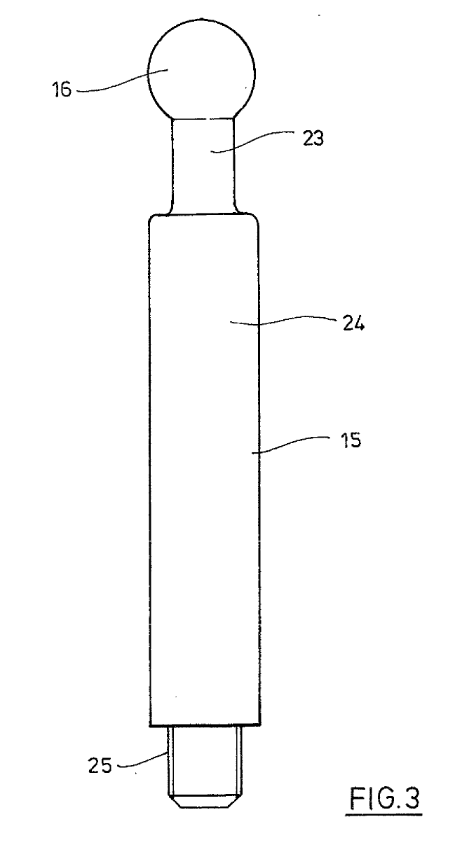

FIG. 3 is an enlarged side view of a locking bolt,

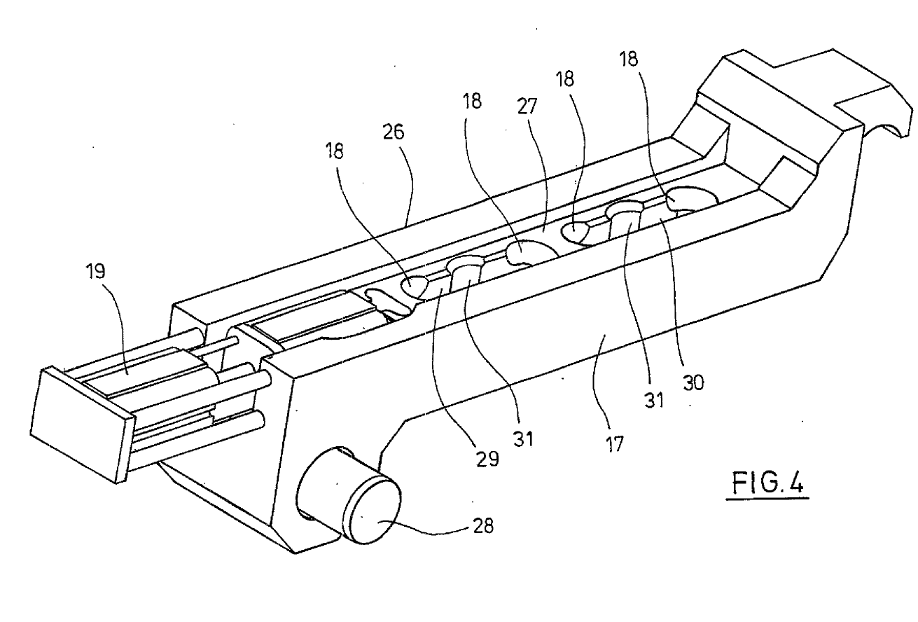

FIG. 4 is a perspective illustration of a fixing element, and

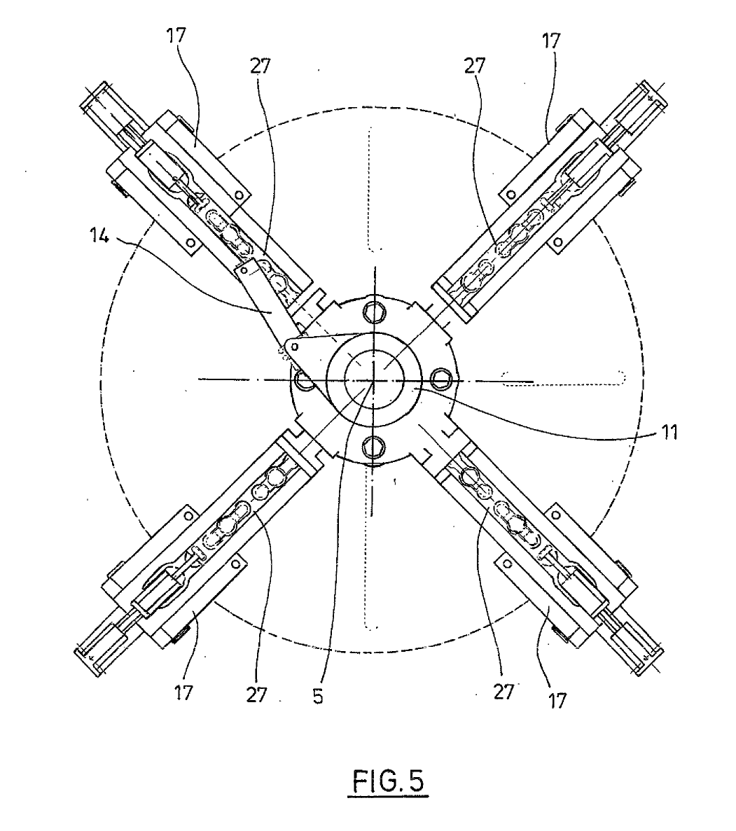

FIG. 5 is a top view of FIG. 4 with fixing elements arranged equidistantly in a radial direction.

In accordance with the embodiment in FIG. 1, a heating press 1 is equipped with mold segments 2, 3 which are arranged in the area of a carrier 4 so as to be positionable transversely of a longitudinal axis 5. The mold segments 2, 3 have on the outer sides thereof inclined positioning surfaces 6, 7 which interact correspondingly with inclined adjusting surfaces 8, 9 of a corresponding base plate 10. As a result, positioning of the mold segments 2, 3 in the direction of the longitudinal axis 5 leads to a forced positioning as a result of the interaction of the inclined positioning surfaces 6, 7 and the inclined adjusting surfaces 8, 9.

For carrying out the positioning movement, the carrier 4 is coupled to a hydraulic cylinder 11. A piston rod 12 of the hydraulic cylinder 11 extends at least over areas thereof through a guide tube 13. Using a pneumatic cylinder 14, the hydraulic cylinder 11 is at least over portions thereof arranged so as to be rotatable about the longitudinal axis 5.

The carrier 4 is provided with holding bolts 15 which engage with bolt heads 16 in fixing elements 17. The bolt heads 16 make available holding profiles which can be inserted into holding recesses 18 of the fixing elements 17. In particular, it is found to be advantageous if the bolt heads 16 are provided with a rounded contour and are inserted into rounded trough-like holding recesses 18.

Locking elements 27 arranged in the area of the fixing elements 17 are positionable transversely of the longitudinal axis 5 by adjusting elements 19. In particular, it is intended to construct the adjusting elements 19 as pneumatic cylinders.

FIG. 2 shows a side view of the upper part of the heating press 1 shown in FIG. 1. Visible in particular is the hydraulic cylinder 11 as well as the pneumatic cylinder 14 fastened to the guide tube 13. The guide tube 13 is mounted so as to be immovable relative to a press frame, so that a positioning movement of the pneumatic cylinder 14 causes a rotating movement of the hydraulic cylinder 11. It is basically possible to use other adjusting elements in place of the pneumatic cylinders 14.

Springs 22 are arranged between two pressure plates 20, 21, wherein the springs can be tensioned or untensioned by using the hydraulic cylinder 11.

FIG. 3 shows an enlarged side view of the holding bolt 15. The holding bolt 15 is provided with a rounded contoured bolt head 16 which is connected through a shaft 23 to a main body 24 of the holding bolt 15. The holding bolt 15 can be fixed in the area of the base plate 10 through an external thread 25.

FIG. 4 shows an enlarged perspective illustration of one of the fixing elements 17. The fixing element 17 has a frame 26 which carries the adjusting element 19 as well as a locking element 27. By using the adjusting element 19, the locking element 27 is movable relative to the frame 26. The frame 26 is mounted so as to be capable of rotary movement through a pivoting joint 28.

As can be seen from FIG. 4, the holding recesses 18 are arranged in the area of the locking element 27. In the illustrated embodiment, the locking element 27 has two slots 29, 30 which are provided each with an insertion recess 31. The insertion recess 31 has a diameter which corresponds at least to an outer diameter of the bolt head 16. A width of the shaft 23 of the holding bolt 15 is dimensioned somewhat smaller than a width of the slots 29, 30. In accordance with the embodiments of FIG. 4, two holding recesses 18 are arranged in the area of each of the slots 29, 30.

For carrying out a locking procedure, initially the holding bolt 15 is guided with its bolt head 16 through the insertion recesses 31. Subsequently, a transverse positioning of the locking element 27 is carried out in such a way that the bolt head 16 is arranged in the area of one of the holding recesses 18. In this state, the fixing element 17 is clamped relative to the bolt head 16. Unlocking takes place in the reverse sequence.

In accordance with the embodiment in FIG. 5, fixing elements 17 are arranged relative to each other essentially equidistantly relative to the longitudinal axis 5 in a circumferential direction 4. It can be seen that the pneumatic cylinder 14 is also arranged for adjusting the hydraulic cylinder 11.

In the following, the function of the locking system is explained in more detail. When the heating press 1 is closed, the holding bolts 15 travel with their bolt heads 16 through the insertion recesses 31 of the fixing elements 17. Subsequently, the locking element 27 is displaced with the use of the adjusting element 19 relative to the longitudinal axis 5 in a radial direction, so that the holding recess 18 is positioned in the area of the ball-like bolt head 16 and causes the bolt head 16 to be blocked as a result. Whether a locking position of the locking element 27 has reached can be called up with the use of safety switches. The number of intended holding recesses 18 defines the number of possible fastening hole circles.

After this positioning of the locking elements 27 relative to the bolt heads 16, the hydraulic cylinder 11 is moved back into its initial position and the springs 22 clamp the pressure plates 20, 21 relative to each other. Because of the coupling to the fixing elements 17, this also results in a clamping of the holding recesses 18 relative to the bolt heads 16. The hydraulic cylinder 11 is subsequently turned into its position of operation by using the pneumatic cylinder 14 and is available for opening and closing the mold segments 2, 3. Because of the clamping which has been carried out the mold is pressed against the heating plate.

A lifting movement of the pressure plate 20 can, in accordance with the embodiment in FIG. 2, be transferred to the adjusting elements 19 by using hollow profiles 32. The adjusting elements 19 engage with end sections in the hollow sections 32.

By rotating the hydraulic cylinder 11 by using the pneumatic cylinder 14, it is possible to let the hydraulic cylinder 11, after a rotation, act on the upper pressure plate 20 and, with a subsequent lifting movement, to push the pressure plate 20 against the pressure plate 21 and to thereby tension the springs 22 and simultaneously pivot the fixing elements 17 about the pivot joints 28 in the direction of the heating plate. After a conclusion of the locking procedure and after moving the hydraulic cylinder 11 back, the springs 22 carry out the necessary clamping without further external influence. After a return rotation of the hydraulic cylinder 11 into the position of operation, there is no further positive engagement present with the pressure plate 20, so that the opening and closing of the heating press 1 can be carried out in the usual manner.

1-24. (canceled)

25. A method for holding a mold of a heating press for tires of an elastomer material, wherein mold segments are releasably held by a support device, comprising the steps of:
guiding holding bolts of a guiding element supporting the mold segments, which holding bolts are provided with a holding profile, through an insertion recess of a fixing element arranged in an area of the support device;
subsequently positioning a locking element of the fixing element transversely of a longitudinal direction of the holding bolts;
locking the holding profile as a result relative to the fixing element;
prior to carrying out the transverse positioning of the locking element, displacing a clamping element for adjusting the fixing element in the longitudinal direction of the holding bolt by an adjusting device against a spring force; and
subsequently returning the clamping element by the spring force in order to hold the holding profile of the holding bolt in an area of the fixing element by positive engagement.

26. The method according to claim 25, including hydraulically driving the adjusting device for the clamping element.

27. The method according to claim 25, including rotating the adjusting device is rotated about its longitudinal axis prior to clamping the clamping element.

28. The method according to claim 27, wherein rotary movement of the adjusting device is predetermined by a pneumatic cylinder.

29. The method according to claim 25, including adjusting the locking element of the fixing element by a pneumatic cylinder.

30. The method according to claim 25, wherein a plurality of fixing elements are spaced apart relative to each other and are aligned with their respective longitudinal axes in a radial direction relative to a longitudinal axis of the adjusting device.

31. The method according to claim 30, wherein the fixing elements are arranged relative to the longitudinal axis in a circumferential direction substantially equidistantly relative to each other.

32. The method according to claim 25, including positioning the locking element by a pneumatic drive.

33. The method according to claim 25, including positioning the holding bolt, when positioning the locking element, by a shaft within a slot of the locking element.

34. The method according to claim 33, including positioning at least one holding recess adapted to a head of the bolt along the slot.

35. The method according to claim 25, including monitoring a locking position by at least one safety switch.

36. The method according to claim 25, including predetermining at least two different locking positions by a positioning of the locking element.

37. A device for holding a mold of a heating press for tires of an elastomer material, comprising:
a support device for releasably holding mold segments;
a fixing element arranged in an area of the support device and having an insertion recess;
a guiding element for supporting the mold segments, the guiding element including holding bolts having a holding profile and being guidable through the insertion recess of the fixing element;
a locking element positionable transversely of a longitudinal direction of the holding bolts, the holding profile being lockable by positioning of the locking element relative to the fixing element; and
a clamping element arranged to displace, in response to an adjusting device, the fixing element in the longitudinal direction of the holding bolts against a spring force of at least one spring, wherein the fixing element is returnable by the spring force of the spring into a retracted position in which the holding bolt is held in an area of the fixing element by positive engagement.

38. The device according to claim 37, wherein the adjusting device for the clamping element is a hydraulic cylinder.

39. The device according to claim 38, wherein the hydraulic cylinder is rotatable relative to a longitudinal axis.

40. The device according to claim 39, and further comprising a pneumatic cylinder for rotating the hydraulic cylinder.

41. The device according to claim 37, wherein the locking element is coupled to a positioning element.

42. The device according to claim 38, wherein a plurality of fixing elements are aligned with their respective longitudinal axes in a radial direction relative to a longitudinal axis of the hydraulic cylinder.

43. The device according to claim 42, wherein the fixing elements are arranged relative to the longitudinal axis in a circumferential direction substantially equidistantly relative to each other.

44. The device according to claim 41, wherein the positioning element for the locking element is a pneumatic cylinder.

45. The device according to claim 37, wherein the locking element has at least one slot into which an insertion opening leads and along which an insertion opening for a head of the bolt is arranged.

46. The device according to claim 37, wherein the bolt head is rounded at least over portions thereof and is adapted to a rounded trough-like contour of the holding recess.

47. The device according to claim 37, and further comprising a safety switch coupled to the locking element.

48. The device according to claim 37, wherein the locking element has at least two different locking positions.
